(19) United States
(12) Patent Application Publication
(10) Pub. No.: US 2014/0021085 A1
(43) Pub. Date: Jan. 23, 2014

(54) PACKAGE ASSEMBLIES AND INTERNAL SUPPORT STRUCTURES FOR TRANSPORT AND STORAGE OF RADIOACTIVE MATERIALS

(71) Applicant: AREVA Federal Services LLC, (US)

(72) Inventors: Charles Joseph Temus, Puyallup, WA (US); Alec Ross, University Place, WA (US); Tom Criddle, Tacoma, WA (US)

(73) Assignee: AREVA Federal Services LLC, Tacoma, WA (US)

(21) Appl. No.: 13/867,909

(22) Filed: Apr. 22, 2013

Related U.S. Application Data
(63) Continuation of application No. 12/254,688, filed on Oct. 20, 2008, now abandoned.
(60) Provisional application No. 60/999,788, filed on Oct. 19, 2007.

(51) Int. Cl. G21F 5/06

(52) U.S. Cl. CPC G21F 5/06
USPC 206/524.6

(57) ABSTRACT

Package assemblies and internal support structures for transport and storage of radioactive material generally include an internal support structure disposed within a container, the internal support structure being made from non-metallic materials. The package is designed to maintain the radioactive material in a subcritical configuration.

### CROSS-REFERENCES TO RELATED APPLICATIONS

This application is a continuation of application Ser. No. 12/254,688, filed Oct. 20, 2008, which claims the benefit of Provisional Application No. 60/999,788, filed Oct. 19, 2007, the disclosures are hereby expressly incorporated by reference herein.

### BACKGROUND

Embodiments of the present disclosure relate generally to package assemblies and internal support structure for the transport and/or storage of radioactive materials. Representative parts of and/or components of known package assemblies are described in the following patent publications and the references listed therein:
Mableson et al. WO 01/22430 A1;
Schlies U.S. Pat. No. 3,446,445;
Ramm U.S. Pat. No. 4,834,917.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a package assembly for radioactive material is provided. The package assembly generally includes an outer container, an inner container disposed within the outer container, and an internal support structure disposed within the inner container, the internal support structure being made from non-metallic materials. The package is designed to maintain the radioactive material in a subcritical configuration.

In accordance with another embodiment of the present disclosure, an internal support structure for a package assembly for radioactive material is provided. The internal support structure generally includes at least one support tray including first and second portions, the first and second portions being made from non-metallic materials. The internal support structure is designed to maintain radioactive material in a subcritical configuration.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a partially cut-away perspective view of a package assembly formed according to various aspects of the present disclosure;

FIG. 2 is an exploded view of the package assembly of FIG. 1;

FIG. 3 is cross-sectional side view of the package assembly of FIG. 1; and

FIGS. 4-7 are partially exploded views of various components of the package assembly of FIG. 1.

### DETAILED DESCRIPTION

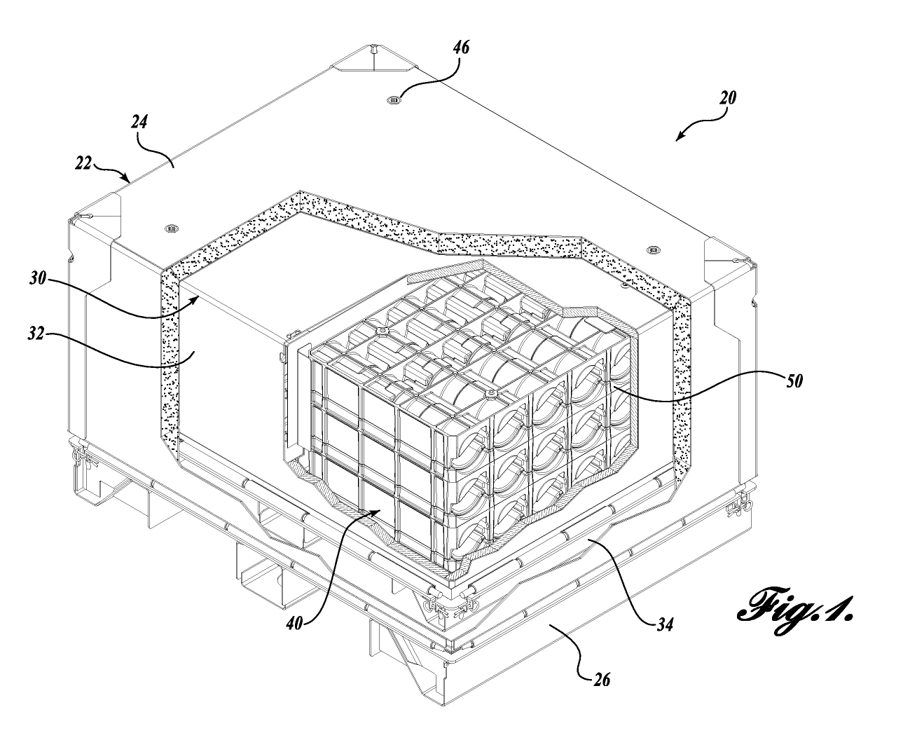

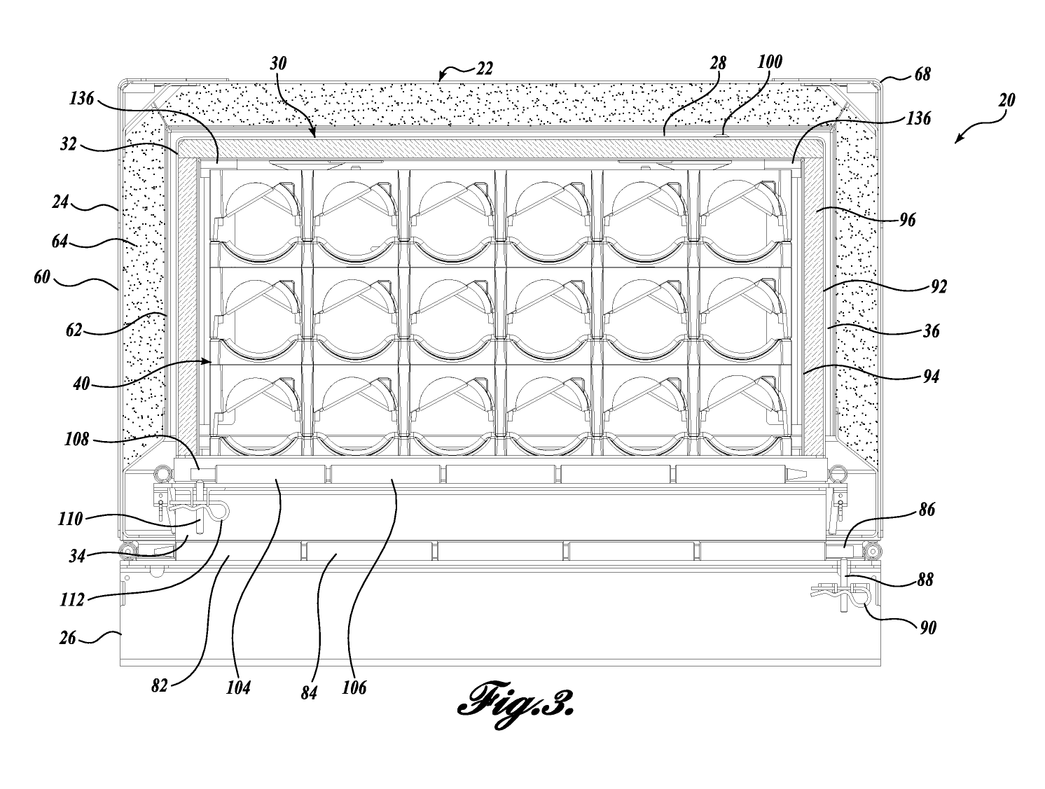

Embodiments of the present disclosure are generally directed to package assemblies for transporting and/or storing radioactive materials, wherein package assemblies generally include non-metallic internal support structures. Referring to FIGS. 1-3, there is shown a package assembly, generally indicated 20, constructed in accordance with one embodiment of the present disclosure. The package assembly 20 generally includes an outer container 22, including a cover portion 24 and a base portion 26 and defining an inner cavity 28 (see FIG. 3). The package assembly 20 further includes an inner container 30 configured to be receivable within the inner cavity of the outer container 22. The inner container 30 includes a cover portion 32 and a base portion 34 and defines a smaller inner cavity 36 (see FIG. 3).

The package assembly 20 further includes an internal support structure 40 configured to be receivable within the inner cavity 36 of the inner container 30. The internal support structure 40 is configured to maintain a suitable geometry for shielding and maintaining criticality control of the contents in the package assembly 20. As described in greater detail below, the internal support structure 40 is constructed from a non-metallic material. In the illustrated embodiment, the internal support structure 40 includes a plurality of support trays 50. However, it should be appreciated that other non-metallic internal support structures 40, such as internal baffles, baskets, wear pads, vibration dampeners, and other support structures of suitable geometry for shielding and maintaining criticality control of the contents in the package assembly 20 are also within the scope of the present disclosure.

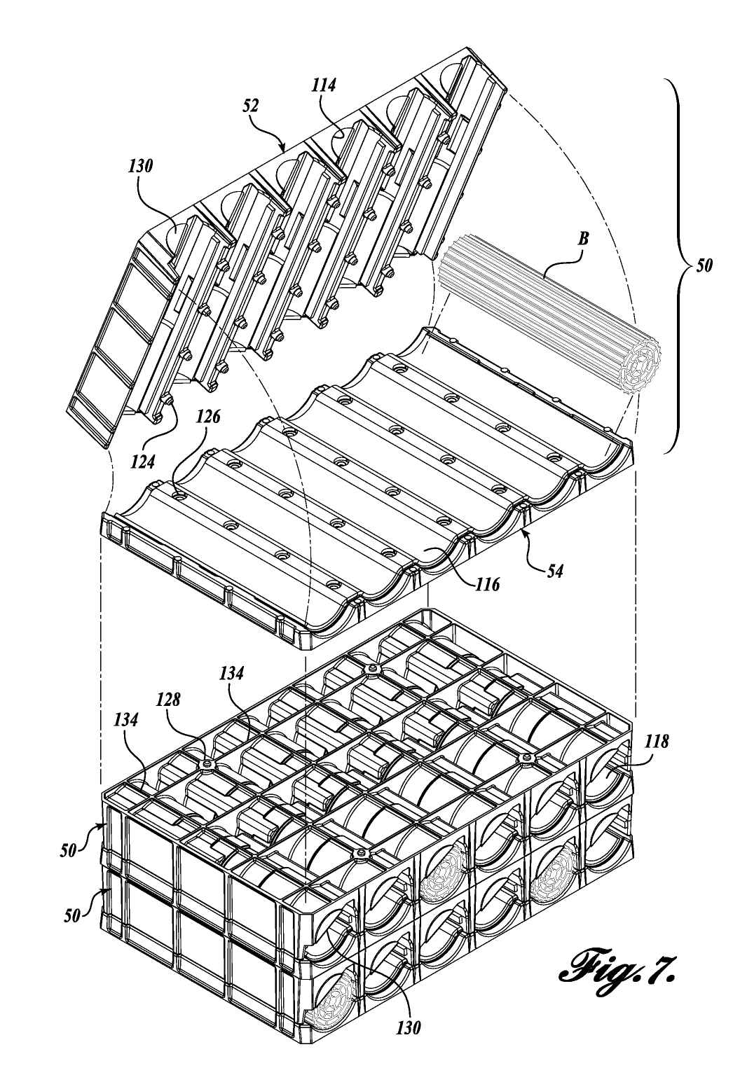

As best seen in FIG. 7 and described in more detail below, the support trays 50 may include first and second portions 52 and 54, and such first and second portions 52 and 54 may be stackable to form the internal support structure. Returning to FIGS. 1-3, it should be appreciated that the metal components of the package assembly 20, for example, portions of the outer and inner containers 22 and 30 may be constructed from steel, for example Type 304 stainless steel having full-thickness fillet welds.

Embodiments of the assembly 20 described herein are designed and configured for the storage and/or transportation of radioactive materials, including but not limited to uranium pellets and fuel rod bundles, such as, for example, low void reactivity fuel (LVRF) bundles, as described in Published International Application No. WO 97/41565, filed on Apr. 23, 1997, the disclosure of which is hereby expressly incorporated by reference herein. In the illustrated embodiment, the assembly 20 includes fuel bundles B (represented in FIG. 7).

The radioactive material may be uranium oxide enriched, for example, in the case of LVRF, up to a maximum of 1.33% and may include dysprosium oxide, which acts as a burnable poison. Accordingly, embodiments of the assembly 20 are minimally designed to protect the transport staff, other people, and the environment from the potentially hazardous material as a result of fire, submersion, impact, or damage to the assembly 20. Minimal design parameters include containment of the radioactive material without release to the environment when subjected to standard crush, drop, puncture, hypothetical fire, and water immersion tests, which are required for assembly certification.

Despite these design certification parameters, it should be appreciated that embodiments of the assembly 20 described herein can also be used to store and/or transport other radioactive or non-radioactive materials, such as fissile fuel assemblies for research reactors, pressurized water reactors, boiling water reactors, pebble bed reactors, and other reactors. The materials may include fuel bundles, fuel pellets, and/or containers of radioactive materials, such as vials, canisters, or other containers.

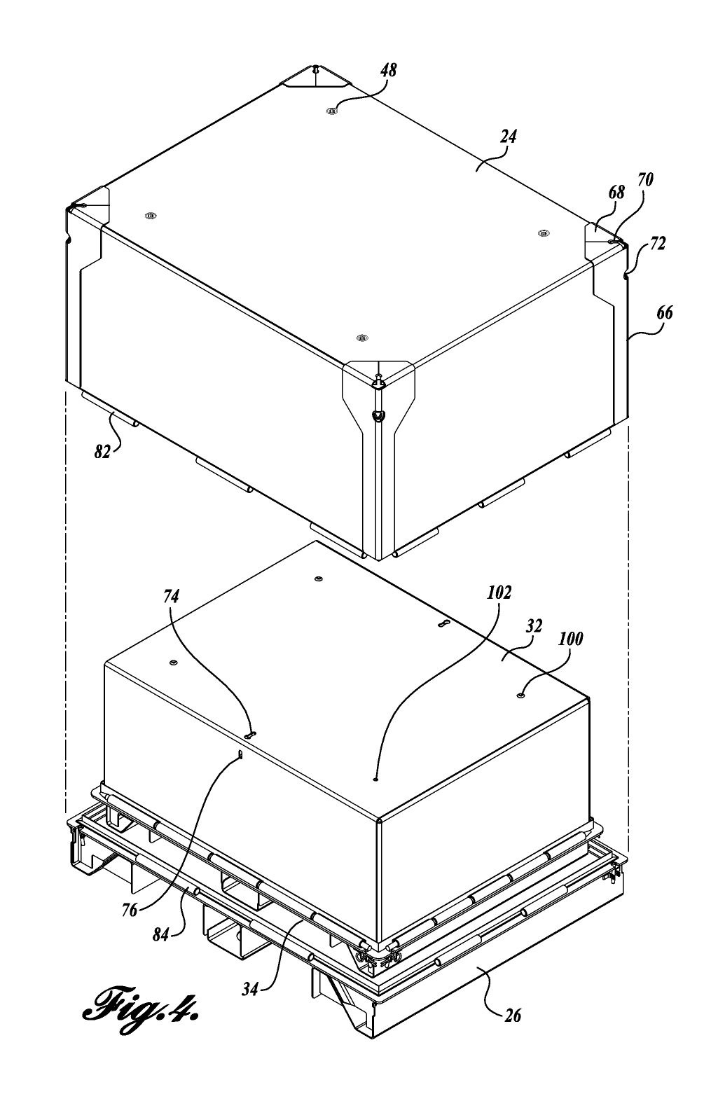

Further, embodiments of the assembly 20 of the present disclosure are generally sized and configured to be transportable, for example, to be carried by suitable transportation means, such as forklifts, highway trucks, and rail cars. However, it should be appreciated that non-portable or stationary assemblies, for example, whether used in storage and/or mixed storage and transportation applications, are also within the scope of the present disclosure. Moreover, the outer and inner containers 22 and 30 are generally designed to be easily handled and opened to allow for periodic inspections of the contents, as seen in exemplary disassembly of the package assembly 20 in the sequence of FIGS. 4-7.

Due to in-plant handling requirements, the various components of the assembly 20 may be designed to be interchangeable. Because the inner containers 30 are generally transported with outer containers 22, but not stored with the outer containers 22, the inner containers 30 are required to be interchangeable with any outer container 22 that is used for transportation. Likewise, because the internal support structures 40 can be moved from one inner container 30 to another during loading and during processing, the internal support structures 40 may also be interchangeable with the inner containers 30. Such interchangeability requires precision manufacturing of individual components.

While embodiments of the assembly 20 described herein generally include an outer container 22, an inner container 30, and an internal support structure 40, it should be appreciated that embodiments of the present disclosure are also directed to discrete elements of the assembly 20, for example, a discrete internal support structure 40 or discrete support trays 50, i.e., without including an inner container 30 or an outer container 22. It should further be appreciated that embodiments of the present disclosure may also be directed to other combinations of components, for example, an internal support structure 40 which may be housed within an inner container 30, i.e., without including an outer container 22.

The individual components of package assembly 20 will now be described in greater detail, beginning with the outer container 22 or overpack assembly. Referring to FIGS. 1-3, the outer container 22 is the outermost container of the assembly 20, and as such, is designed to provide suitable protection for its contents. In that regard, the outer container 22 is particularly designed to withstand accident conditions with minimal damage to the outer container 22 or any contents housed inside. Such accident conditions include normal conditions of transport (NCT) 4-foot free drops (e.g., flat side drops, CG over top corner drop, and CG over bottom short edge), accident conditions of transport (ACT) 30-foot free drops (e.g., flat side drops, CG over top corner drop, and CG over bottom short edge), and puncture drop test (e.g., dropping the package assembly on a 6-inch diameter steel bar from a height of 40 inches).

In the illustrated embodiment, the outer container 22 is generally a flat-sided rectangular box including a cover portion 24 and a base portion 26 and defining an inner cavity 28. In one non-limiting example, the flat-sided rectangular box may have a length of about 52 inches, a width of about 41.6 inches, and a height of about 31.6 inches. It should be appreciated, however, that other shapes and sizes of outer containers are within the scope of the present disclosure, so long as they mate with the other components of the assembly 20.

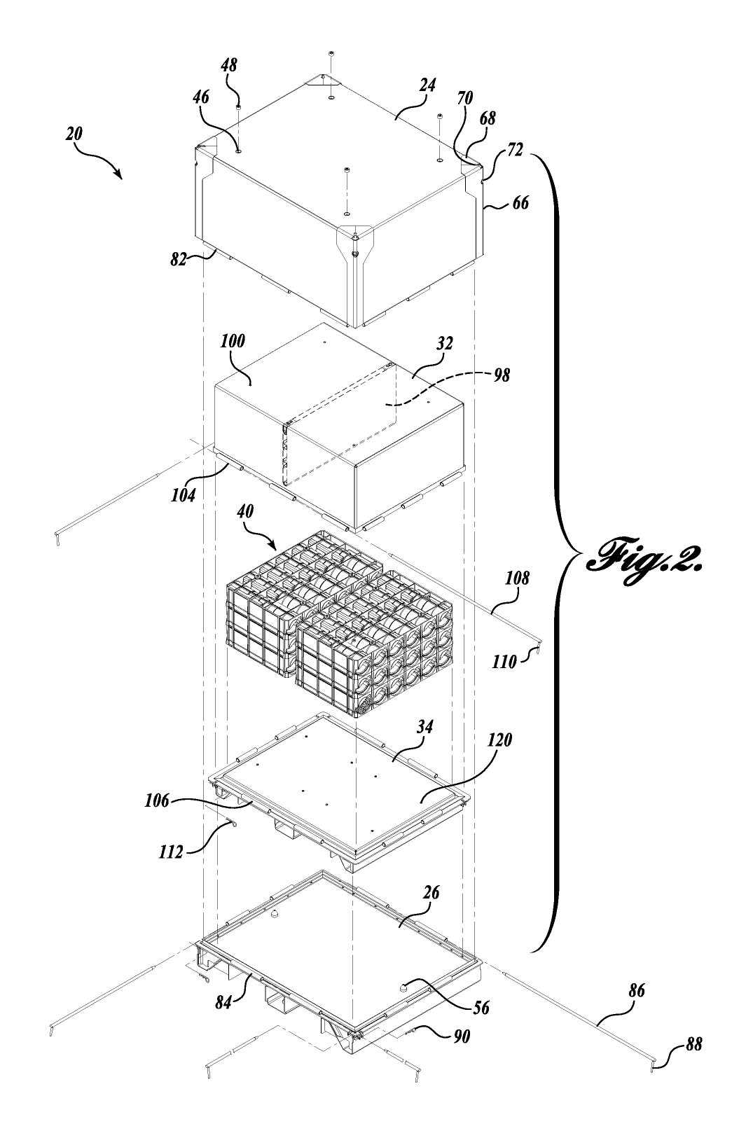

The base portion 26 of the outer container 22 is made from a suitable supportive material, such as a ¼-inch thick steel plate, and is supported by formed sheet steel that creates a raised structure on the base portion 26, which is designed to be compatible with the forks of a forklift truck. As seen in FIG. 2, the top side of the base portion 26 may include locating pins 56 that can be received within locator holes or sockets on the bottom side of the base portion 34 of the inner container 30 for locating the inner container 30 within the outer container 22.

Referring to FIG. 3, the cover portion 24 of the outer container 22 is preferably made in a sandwich construction including an outer layer 60, such as an outer steel sheet, an inner layer 62, such as an inner steel sheet, and a cushioning layer 64 in between the outer and inner layers. The cushioning layer 64 may be any suitable shock dampening, compressive, or cushioning material, including, but not limited to 10 lb/ft³ polyurethane foam. As one non-limiting example of a suitable cover portion 24 sandwich construction, the cover portion 24 includes a 0.13-inch thick outer steel sheet 60, a 0.08-inch thick inner steel sheet 62, and a 2.3-inch thick cushioning layer 64 including nominally 10 lb/ft³ polyurethane foam in between the outer and inner layers 60 and 62. The cushioning layer 64 is preferably sealed between the inner and outer layers 60 and 62 to prevent moisture intrusion.

The edges and corners of the outer container 22 are preferably reinforced to improve the integrity of the outer container 22. Referring to FIGS. 2 and 3, the four vertical edges 66 and the top corners 68 may be reinforced with double sheets, for example, 0.13-inch thick outer steel sheet for reinforcement. In addition, the top corners 68 may be formed to create lifting pockets 70 (FIG. 2) for the purpose of lifting the cover portion 24 from the base portion 26. The external opening of each pocket 70 may include a slot that is designed to mate with a cable and swaged end fitting. Moreover, each pocket 70 may include a drain hole 72 to allow water to drain out. While the lifting pockets 70 are shown in the illustrated embodiment at each of the four top corners 68 of the outer container 22, it should be appreciated that pockets may be suitably located at any position on the cover portion 24.

Attachment of the cover portion 24 to the base portion 26 may be achieved by any suitable attachment method. In the illustrated embodiment, the cover portion 24 is attached to the base portion 26 by a tube and rod attachment system. Referring to FIGS. 2 and 3, the cover portion 24 includes a plurality of tubes 82 at the lower end of the cover portion 24 framework. In addition, the base portion 26 includes a plurality of alternating tubes 84 that interdigitate with the tubes on the cover portion 24. As one non-limiting example, the tubing may be 1-inch outer diameter by 0.12-inch wall thickness steel tubes. In the illustrated embodiment, three tubes 82 are attached to the cover portion 24 and two alternating tubes 84 are attached to the base portion 26. However, it should be appreciated that other tube configurations are also within the scope of the present disclosure.

One or more retaining rods 86 can be inserted (or “stitched”) into the alternating tubes 82 and 84 to secure the cover portion 24 to the base portion 26 through the tubes 82 and 84. The rods 86 may be tapered at one end and are approximately equal in length to the side of the outer container 22 to which they connect. Each rod 86 may have a short handle 88 at one end, which may be used to slide the rod 86 into place, but also may be used to secure a fully inserted rod 86. In that regard, once the rod 86 has been inserted, the handle 88 may be rotated into a secured position adjacent the base portion 26 of the outer container 22 (see FIG. 3). The rod 86 may then be secured in place by a retainer pin 90, such as a hitch pin, or any other suitable securement device, ensuring that the retaining rods 86 stay in place and that the cover portion 24 of the outer container 22 remains attached to the base portion 26. The tube and rod attachment system provides a strong yet compliant joint that is capable of sustaining local damage without loss of integrity.

When assembled, any gap between the cover portion 24 and the base portion 26 may be closed by a dust seal, for example, a braided ceramic sleeving material, which may be attached to the base portion 26 of the outer container 22 by adhesive or another suitable attachment method.

The cover portion 24 for the outer container 22 may further include a ventilation mechanism to release any gases generated in the assembly 20, for example, in a fire event. In one suitable embodiment, the ventilation mechanism is one or more fire-consumable plugs 48 located in a ventilation hole 46 on the external surface of the cover portion 24 of the outer container 22 (see FIGS. 2 and 4).

Referring to FIGS. 2-4, the inner container 30 or cargo assembly will now be described in greater detail. The inner container 30 is designed to protect and confine radioactive material, for example, fuel bundles, or other contents being contained during transport (together with the outer container 22) and during storage (typically without the outer container 22). During transport, the outer container 22 generally provides drop and normal handling protection, and the inner container 30 generally provides fire protection. Because there is little risk of drop or handling accidents during storage, the inner container 30 can be used to store the radioactive material without an outer container 22.

In the illustrated embodiment, the inner container 30 is generally a flat-sided rectangular box including a cover portion 32 and a base portion 34 and defining an inner cavity 36. As seen in FIGS. 2-4, the inner container 30 is designed to be received by and fit within the inner cavity 28 of the outer container 22. In one non-limiting example, the flat-sided rectangular box may have a length of about 48.1 inches, a width of about 37.7 inches, and a height of about 22.7 inches. It should be appreciated, however, that other shapes and sizes of inner containers are within the scope of the present disclosure, so long as they mate with the other components of the assembly 20.

As seen in FIG. 3, the walls of the cover portion 32 of the inner container 30 are preferably made in a sandwich construction including an outer layer 92, such as an outer steel sheet, an inner layer 94, such as an inner steel sheet, and a refractory thermal insulation layer 96 in between the outer and inner layers 92 and 94. The insulation layer 96 may be any suitable insulation material, including, but not limited to ceramic insulation, for example, alumina silica insulation, such as the composite manufactured by UNIFRAX under the trade name FIBERFRAX® DURABOARD TYPE LD. As one non-limiting example of a suitable cover portion 32 sandwich construction, the cover portion 32 includes a 0.13-inch thick outer steel sheet 92, a 0.08-inch thick inner steel sheet 94, and a 1-inch thick insulation layer 96 in between the outer and inner layers 92 and 94. The insulation layer 96 is preferably sealed between the inner and outer layers 92 and 94 to prevent moisture intrusion. In one embodiment, all sides of the inner container 30 (including side walls and top wall of the cover portion 32) include refractory thermal insulation.

The cover portion 32 may include a center wall 98 coupled to the interior of the cover portion 32. The center wall 98 can be used to divide the inner cavity 36 of the inner container 30 into two portions. As a non-limiting example, the center wall 98 may have a cross-sectional thickness of 1.5 inches constructed of two 0.08-inch steel sheets separated by U-shaped reinforcements. The lower edge of the center wall 98 may further be reinforced, for example, by a 1-inch diameter by 0.12-inch wall thickness steel tube.

The cover portion 32 may further include lifting pockets 74 for the purpose of lifting the cover portion 32 from the base portion 34 of the inner container 30 (see FIG. 4) Like the lifting pockets 70 on the outer container 22, the external opening of each pocket 74 may include a slot that is designed to mate with a cable and swaged end fitting. Each pocket 74 may also include a drain hole 76 to allow water to drain out. In the illustrated embodiment, the pockets 74 are located at the middle of each long top edge of the cover portion 32; however, it should be appreciated that pockets may be suitably located at any position on the cover portion 32.

Like the cover portion 24 for the outer container 22, the cover portion 32 for the inner container 30 may further include a ventilation mechanism to release any gases generated in the inner container 30, for example, in a fire event. In one suitable embodiment, the ventilation mechanism is one or more fire-consumable plugs 100 located in ventilation holes 102 on the external surface of the cover portion 32 of the inner container 30 (see FIG. 4).

The base portion 34 of the inner container 30 is made from a suitable supportive material, such as a ¼-inch thick steel plate, and is supported by formed sheet steel that creates a raised structure on the base portion 34. Like the base portion 26 of the outer container 22, the base portion 34 of the inner container 30 is designed to be compatible with the forks of a forklift truck. In one embodiment, at least a portion of the base portion 34 (for example, the central region of the base portion 34) may be covered with a ceramic insulating layer, such as a 1-inch thick layer of ceramic insulating board, enclosed within a steel wall, such as a 0.13-inch thick steel sheet, which is suitably affixed, for example, by welding to the base portion 34.

Attachment of the cover portion 32 to the base portion 34 may be achieved by any suitable attachment method. In the illustrated embodiment, the cover portion 32 is attached to the base portion 34 by a tube and rod attachment system, similar to the tube and rod attachment system for the outer container 22 described above. In that regard, the cover portion 32 includes a plurality of tubes 104 at the lower end of the cover portion 32 framework. In addition, the base portion 34 includes a plurality of alternating tubes 106 that interdigitate with the tubes 104 on the cover portion 32. As one non-limiting example, the tubing may be 1-inch outer diameter by 0.12-inch wall thickness steel tubes. One or more rods 108 can be inserted (or “stitched”) into the tubes 104 and 106 to secure the cover portion 32 to the base portion 34 through the tubes 104 and 106. In the illustrated embodiment, the rods 108 are secured by a handle 110 and retainer pin 112 securement system.

When assembled, any gap between the cover portion 32 and the base portion 34 may be closed by a dust seal, for example, braided ceramic sleeving material, which may be attached to the base portion 34 of the inner container 30 by adhesive or another suitable attachment method.

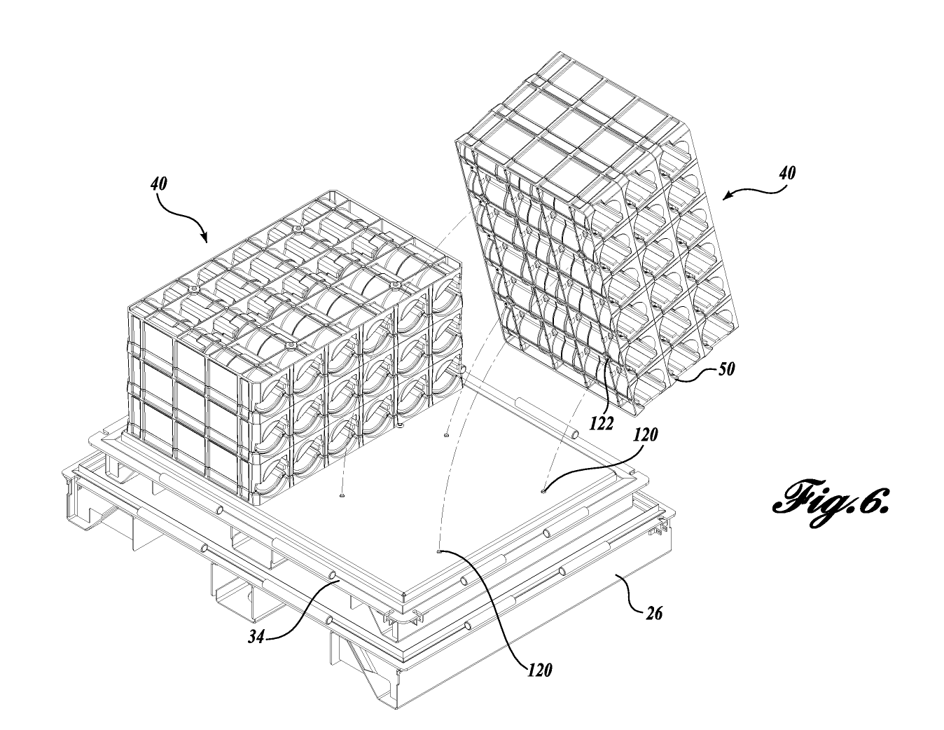

Referring to FIGS. 6 and 7, the internal support structure 40 will now be described in greater detail. The internal support structure 40 is configured to maintain the radioactive material in a subcritical configuration, and includes a plurality of discrete support trays 50. In one embodiment, the one or more discrete support trays 50 are stackable upon one another (see FIG. 7).

Referring to FIG. 7, the support trays 50 of the illustrated embodiment include first and second portions 52 and 54, wherein the first and second portions 52 and 54 are, respectively, upper and lower portions. In the illustrated embodiment, the first and second portions 52 and 54 include grooves 114 and 116 that when fit together form substantially horizontal cylindrical cavities 118. The substantially horizontal cylindrical cavities 118 are designed to contain and protect a plurality of fuel bundles B. As a non-limiting example, the first portion 52 of a support tray 50 is about 3.9 inches tall and the second portion 54 of a support tray 50 is about 1.4 inches tall. However, it should be appreciated that out shapes and sizes of support trays 50 are within the scope of the present disclosure, so long as they mate with the other components of the assembly 20.

Locating devices may be used to locate first and second portions 52 and 54 of individual support trays 50, adjacent support trays 50, stacking support trays 50, as well as locating the support trays 50 to the inner container 30. In the illustrated embodiment, the top side of the base portion 34 includes a plurality of locating pins 120 (see FIG. 6) that can be received within locator holes or sockets 122 on the bottom side of the second portion 54 of a support tray 50 for locating the support tray 50 within the inner container 30. In addition, as seen in FIG. 7, stacking support trays 50 include locator pins 124 and locator holes 126 in respective first and second portions 52 and 54 of individual support trays 50 on top of one another. In the illustrated embodiment, the locator pins 124 and locator holes 126 are positioned on respective first and second portions 52 and 54 on the ridges between respective grooves 114 and 116 that form horizontal cylindrical cavities 118. Moreover, adjacent support trays 50 may include locator pins 128 and locator holes or sockets 122 between adjacent stacking second portions 54 and first portions 52.

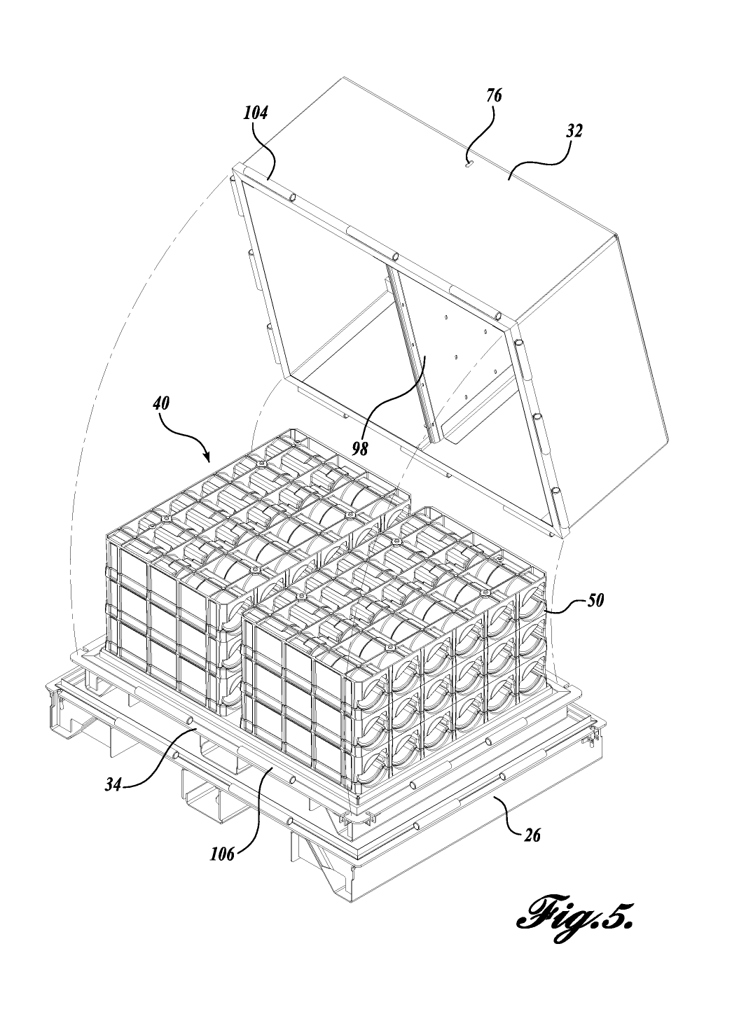

Referring to FIGS. 5-7, three support trays 50 in a stack are shown, each support tray 50 being configured to hold six fuel bundles B, such that a stack of three holds eighteen fuel bundles B. The two stacks supported by the assembly 20 hold a total of thirty-six fuel bundles. However, it should be appreciated that other configurations to hold any number of fuel bundles are also within the scope of the present disclosure. It should further be appreciated that the support trays may include suitable stops to keep the contents in place. As a non-limiting example, the support trays in the illustrated embodiment include end stops 130 to keep the fuel bundles from sliding within the support trays 50 or out the sides of the support trays 50 if the support trays 50 are tipped at an angle.

While shown as forming substantially horizontal cylindrical cavities 118, it should be appreciated that the first and second portions 52 and 54 may be configured in other configurations to optimally contain fuel bundles, fuel pellets, other radioactive materials, and/or containers of radioactive materials, or other materials. The internal support structure 40 is suitably designed to protect the contents it carries, while allowing easy access to the contents for regulatory verification and inspection. The internal support structure 40 must also be compatible with probes, such as radiation sensing probes, used by inspectors, for example, to allow access and minimize probe interference.

As mentioned above, the internal support structure 40 is made from non-metallic materials. The internal support structure 40 is preferably manufactured from a material having a resistance to brittle fracture behavior at high strain rates (accident conditions of transport, such as a 30-foot free drops) and an ability to withstand temperatures associated with the regulatory fire and added storage area fire (such as a 30 minute, 550° C. storage area fire). The internal support structure 40 preferably has heat resistance up to about 500° F.

In one suitable embodiment, the internal support structure 40 may have a minimum tensile strength of 22 ksi. In another suitable embodiment, the internal support structure 40 may have a minimum Izod impact (notched) of 23 ft-lb/in. The tensile and impact strength of the support trays are directly related to design of the internal support structure 40 and the specifications depend on specific design configurations and payload requirements.

In one suitable embodiment, the internal support structure 40 may be made from a composite material, such as a lightweight polymer molding compounds. In accordance with embodiments of the present disclosure, the polymer may be reinforced with fibers including, but not limited to Kevlar, graphite, stainless steel, fiberglass fibers, and combinations thereof. In one embodiment, a fiberglass reinforced polyester trays were modeled with a density of 1.84 g/cm³ (nominal density is 1.92 g/cm³). In another embodiment, a suitable density for the fiberglass reinforced polymer trays is in the range of about 0.6 g/cm³ to about 2.8 g/cm³.

Suitable molding compounds may include both reinforced and unreinforced thermosets and thermoplastics. However, it should be appreciated that any moldable polymer material which meets the structural and thermal requirements is acceptable. As non-limiting examples, suitable thermosets may include polyester, vinylester and epoxy resins. As non-limiting examples, suitable thermoplastics may include polyetheretherketone (PEEK) and polyaryletherketon (PAEK).

The material may be provided as a pre-cured sheet, which is then molded into tray components by the application of pressure and heat. In another embodiment, the composite material that makes up the support tray assemblies includes a flame retardancy or suppressant compound, such as zinc, antimony, bromine, aluminum tri-hydrate, or any other specified flame retardant or suppressant.

As a non-limiting example, the support trays 50 may be molded from a reinforced polyester resin having a uniform thickness of about 3/16 inch along the cavity designed to receive the fuel bundles or containers. In addition, as another non-limiting example, the support trays 50 may include a reinforcing web on the back side of each tray portion having a thickness of about 3/16 inch to impart additional strength and stiffness to the support trays 50. As yet another non-limiting example, the support trays 50 may be lined with a cushioning foam, such as a elastic polyurethane foam, to provide a soft interface for the radioactive material to help secure the radioactive material in the support trays 50. Such foam may be attached to the support trays 50 with adhesive.

Suitable methods of making thermoset polymer internal support structures may include one or more of the following methods: (1) traditional wet lay-up; (2) resin transfer molding (RTM); (3) RTM-lite; (4) bulk molding compound (BMC) or sheet molding compound (SMC); and (5) epoxy prepreg. Suitable methods for making thermoplastic polymer support structure may include one or more of the following methods: (1) injection molding; (2) vacuum forming; and (3) structural foam molding. Other molding processes may be used for both fiber reinforced polymers, unreinforced polymers, as well as other compounds.

The internal support structure 40 may optionally include wear pads and/or vibration dampeners to protect the internal support structure 40 from wear. Because the internal support structure 40 is a non-metallic structure, if not protected, if may tend to wear at any interface between separate components of the internal support structure 40 and at any interface between the internal support structure 40 and the inner container 30. Such wearing may produce unwanted dust in the package assembly 20 or may affect the integrity of the package assembly 20.

As seen in FIG. 7, the support trays 50 of the illustrated embodiment may include protective linings or wear pads at the interfaces between the first and second portions 52 and 54 of the support trays 50. As non-limiting examples, interfacing locator pins 124 and/or locator holes 126 of respective first and second portions 52 and 54 of the support trays 50 may include protective linings or wear pads. In addition, interfacing locator pins 128 and locator holes 122 (see FIG. 6) between adjacent stacking second portions 54 and first portions 52 may include protective linings. Moreover, other interfacing regions of the support trays 50, such as ribs 134 created during the molding of polymer support trays, may include protective linings or wear pads. Suitable wear pads may be manufactured from polyethylene or other wear resistant compounds.

Referring to FIG. 3, the internal support structure 40 may further include one or more preload mechanisms 136 for vibrational dampening to further prevent wear to the internal support structure 40. In the illustrated embodiment, the preload mechanisms are shown as compression structures, such as compressive foam, located in the upper corners of the inner container 30. However, it should be appreciated that suitable preload mechanisms may be located in any position surrounding the internal support structure 40. As one non-limiting example, the preload mechanism 136 may be integrally formed with the cover portion 32 of the inner container 30. As another non-limiting example, the preload mechanism 136 may be integrally formed with the base portion 34 of the inner container 30. It should further be appreciated that other types of preload mechanisms are within the scope of the present disclosure, including but not limited to springs, biasing members, and other compressive structures.

### Example

### Tray Material Composition

In one non-limiting example, a suitable light weight fiberglass reinforced polyester resin thermoset support tray modeled with a density of 1.84 g/cm³ (nominal density is 1.92 g/cm³) included the following composition:

| Component | Wt % | Assumed Wt % |
|---|---|---|
| C | 25 | 25 |
| O | 38 | 38 |
| H | 2 | 2 |
| Br | 2 | 2 |
| Sb | 1 | 1 |
| Ca | 8 | 8 |
| N | 1 | 1 |
| Si | 18 | 23 |
| Other | 5 | 0 |

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While illustrative embodiments have been illustrated and described, it will be appreciated that various changes can be made therein without departing from the spirit and scope of the invention.

The embodiments of the invention in which an exclusive property or privilege is claimed are defined as follows:

1. A package assembly for radioactive material, comprising:
(a) an outer container;
(b) an inner container disposed within the outer container;
(c) an internal support structure disposed within the inner container, wherein the internal support structure includes at least one support tray having lower and upper portions that fit together to form a cavity designed to receive the radioactive material, wherein the lower and upper portions have a wall thickness that is substantially uniform along the cavity, the internal support structure being made from a thermoset material comprising a polyester thermoset or a vinylester thermoset or both a polyester thermoset and a vinylester thermoset, the thermoset material having heat resistance up to about 500 F., and wherein the internal support structure is reinforced with fibers selected from the group consisting of Kevlar, graphite, stainless steel, fiberglass, and combinations thereof.

2. The package assembly of claim 1, wherein the at least one support tray is made from a fiberglass reinforced polyester resin thermoset molding compound.

3. The package assembly of claim 1, wherein the internal support structure includes a plurality of support trays.

4. The package assembly of claim 1, wherein the internal support structure includes a flame retardancy compound.

5. The package assembly of claim 1, wherein the internal support structure is lined with a cushioning foam to secure the radioactive material.

6. The package assembly of claim 1, wherein at least a portion of the outer container has a sandwich construction including an inner layer of polyurethane foam.

7. The package assembly of claim 1, wherein at least a portion of the inner container has a sandwich construction including an inner layer of refractory thermal insulation.

8. The package assembly of claim 1, wherein the inner container includes one or more preload mechanisms for dampening vibrations to the internal support structure.

9. The package assembly of claim 1, wherein the radioactive material is selected from the group consisting of fuel assemblies, fuel pellets, fuel rods, and containers of radioactive material.

10. A package assembly for radioactive material, comprising:
(a) a container; and
(b) an internal support structure disposed within the container, wherein the internal support structure includes at least one support tray having lower and upper portions that fit together to form a cavity designed to receive the radioactive material, wherein the lower and upper portions have a wall thickness that is substantially uniform along the cavity, the internal support structure being made from a thermoset material comprising a polyester thermoset or a vinylester thermoset or both a polyester thermoset and a vinylester thermoset, the thermoset material having heat resistance up to about 500 F., and wherein the internal support structure is reinforced with fibers selected from the group consisting of Kevlar, graphite, stainless steel, fiberglass, and combinations thereof.

11. The package assembly of claim 10, wherein at least a portion of the container has a sandwich construction including an inner layer of refractory thermal insulation.

12. An internal support structure for a package assembly for radioactive material, the support structure comprising:
at least one support tray including first and second portions that fit together to form a cavity designed to receive the radioactive material, wherein the lower and upper portions have a wall thickness that is substantially uniform along the cavity, the first and second portions being made from a thermoset material comprising a polyester thermoset or a vinylester thermoset or both a polyester thermoset and a vinylester thermoset, the thermoset material having heat resistance up to about 500 F., and wherein the internal support structure is reinforced with fibers selected from the group consisting of Kevlar, graphite, stainless steel, fiberglass, and combinations thereof.
